(19) United States
(12) Patent Application Publication
(10) Pub. No.: US 2023/0318116 A1
(43) Pub. Date: Oct. 5, 2023

(54) BATTERY PACK

(71) Applicant: Prime Planet Energy & Solutions, Inc., Tokyo (JP)

(72) Inventors: Koji FUJINAGA, Kakogawa-shi (JP); Daichi KOBORI, Kobe-shi (JP); Motoshi ISONO, Toyota-shi (JP)

(21) Appl. No.: 18/192,652

(22) Filed: Mar. 30, 2023

(30) Foreign Application Priority Data
Mar. 31, 2022 (JP) 2022-059881

(51) Int. Cl. H01M 50/293; H01M 50/209; H01M 50/367

(52) U.S. Cl. CPC H01M 50/293; H01M 50/209; H01M 50/367

(57) ABSTRACT

A battery pack disclosed herein includes a plurality of rectangular secondary batteries, a porous elastic member disposed between the rectangular secondary batteries, and a restriction mechanism that applies a restriction load on the rectangular secondary batteries and the porous elastic member. The porous elastic member includes a gas flow channel extending from an outer edge to the inside in a state where the porous elastic member is assembled to the battery pack.

### CROSS REFERENCE TO RELATED APPLICATION

This application claims the benefit of priority to Japanese Patent Application No. 2022-059881 filed on Mar. 31, 2022. The entire contents of this application are hereby incorporated herein by reference.

### BACKGROUND OF THE DISCLOSURE

### 1. Field

The present invention relates to a battery pack.

### 2. Background

In power sources for vehicle driving or the like, battery packs in which a plurality of secondary batteries (cells) are electrically connected to each other for higher output have been used conventionally. Conventional technical literatures related to the battery pack include WO 2018/061894 and Japanese Utility Model Registration No. 3191519. For example, WO 2018/061894 discloses a battery pack including a plurality of secondary batteries that are arranged in a predetermined arrangement direction, a heat conduction suppressing member with a sheet shape that is disposed between the secondary batteries adjacent in the arrangement direction and includes a heat insulating material, and a restriction mechanism that applies a restriction load on the secondary batteries and the heat conduction suppressing member from the arrangement direction.

In WO 2018/061894, the heat insulating material of the heat conduction suppressing member has a structure in which a porous material such as silica xerogel is carried between fibers of a fiber sheet. The porous material includes a plurality of communication holes that communicate with the outside. Thus, if the restriction mechanism restricts the secondary batteries from the arrangement direction, the heat conduction suppressing member is crushed and compressed in the arrangement direction while discharging air in the porous material. That is to say, the heat conduction suppressing member deforms elastically.

### SUMMARY

Incidentally, when the battery pack is used, each of the secondary batteries in the battery pack is charged and discharged. When the secondary battery is charged, an electrode body in a battery case expands and the thickness of the secondary battery in the arrangement direction increases. Accordingly, the load on the porous material becomes large and the porous material is further compressed in the arrangement direction. Since the porous material is compressed in this manner, the excessive restriction load that is more than or equal to a predetermined load can be prevented from being applied on the secondary battery.

On the other hand, when the secondary battery is discharged, the electrode body in the battery case shrinks and the thickness of the secondary battery in the arrangement direction decreases. According to examinations by the present inventors, however, even if the thickness of the secondary battery decreases in the discharge, the thickness of the porous material in the arrangement direction is not returned to the original one, that is, it has been difficult for the porous material to become the original size. As a result, the restriction load in the discharge becomes smaller than a desired value, so that the secondary battery may not be pressed sufficiently. Especially in a case where a state of charge (SOC) is less than or equal to 15%, this tendency is remarkable.

The present invention has been made in view of the above circumstances and a main object of the present invention is to provide a battery pack in which, even in a case where a state of charge is low, a restriction load does not decrease easily and the restriction load can be stably applied on a secondary battery.

The present inventors have examined the reason why the thickness of a porous material in an arrangement direction is not returned to the original one in a low SOC such as in discharge, and then, have newly found out that the porous material cannot inhale air suitably. That is to say, in the structure in WO 2018/061894, the porous material is tightly held between the side surfaces of the secondary batteries and the porous material is hardly exposed to outside air. The porous material needs to inhale gas in order to be returned to the original thickness. However, it has been discovered that if a part exposed to outside air is small as described above, inhaling gas is insufficient and the thickness is not returned to the original one even in a case where the restriction load is relieved. In view of this, the present invention has been made.

The present invention discloses a battery pack including: a plurality of rectangular secondary batteries that are disposed along a predetermined arrangement direction; a porous elastic member that is disposed between the rectangular secondary batteries that are adjacent in the arrangement direction; and a restriction mechanism that applies a restriction load on the rectangular secondary batteries and the porous elastic member from the arrangement direction. The porous elastic member includes a plurality of communication holes that communicate with outside and is configured to be deformable elastically in the arrangement direction by taking in or discharging gas. The battery pack satisfies at least one of the following structures (1) and (2): (1) the porous elastic member includes a gas flow channel extending from an outer edge to inside in a state where the porous elastic member is assembled to the battery pack; and (2) a different member is additionally provided between the rectangular secondary battery and the porous elastic member, and the different member includes the gas flow channel extending from the outer edge to the inside on at least a surface that is in contact with the porous elastic member in a state where the different member is assembled to the battery pack.

In the present invention, even in a state where assembling to the battery pack is completed and the restriction load is applied, the gas flow channel that communicates with the porous elastic member is secured. Thus, when the secondary battery shrinks in the discharge or the like, a gas (typically, air) around the battery back is relatively easily taken in through the gas flow channel to the inside of the porous elastic member compared with the structure disclosed in WO 2018/061894, for example. As a result, the porous elastic member expands suitably and is easily returned to the original size (especially, the thickness in the arrangement direction). Therefore, even when the secondary battery shrinks, a state where the rectangular secondary battery is stably pressed can be maintained and a decrease of the restriction load of the battery pack can be suppressed.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view schematically illustrating a battery pack according to an embodiment;

FIG. 2 is a perspective view schematically illustrating a secondary battery in FIG. 1;

FIG. 3 is a schematic longitudinal cross-sectional view taken along line in FIG. 2;

FIG. 4 is a perspective view schematically illustrating an electrode body group attached to a sealing plate;

FIG. 5 is a perspective view schematically illustrating one electrode body;

FIG. 6 is a schematic view illustrating a structure of the electrode body;

FIG. 7 is a plan view schematically illustrating a positional relation between a rectangular secondary battery and a porous elastic member;

FIG. 8 is a partial enlarged view of a main part of the battery pack in FIG. 1 viewed from above, and a top view schematically illustrating the rectangular secondary batteries and the porous elastic member;

FIG. 9 is a diagram corresponding to FIG. 7 in a first modification;

FIG. 10 is a diagram corresponding to FIG. 7 in a second modification;

FIG. 11A is a diagram corresponding to FIG. 7 in a third modification, and FIG. 11B is a cross-sectional view taken along line (b)-(b) in FIG. 11A; and

FIG. 12A is a plan view schematically illustrating a positional relation among the rectangular secondary battery, the porous elastic member, and a different member, and FIG. 12B is a diagram corresponding to FIG. 8 in a fourth modification.

### DETAILED DESCRIPTION OF THE PREFERRED EMBODIMENTS

Preferred embodiments of a battery pack disclosed herein will be described below with reference to the drawings as appropriate. Matters other than matters particularly mentioned in the present specification and necessary for the implementation of the present invention (for example, the general configuration and manufacturing process of a rectangular secondary battery that do not characterize the present invention) can be grasped as design matters of those skilled in the art based on the prior art in the relevant field. The battery pack disclosed herein can be implemented on the basis of the disclosure of the present specification and common technical knowledge in the relevant field.

Note that in the drawings below, the members and parts with the same operation are denoted by the same reference signs and the overlapping description may be omitted or simplified. Moreover, in the present specification, the notation “A to B” for a range signifies a value more than or equal to A and less than or equal to B, and is meant to encompass also the meaning of being “preferably more than A” and “preferably less than B”.

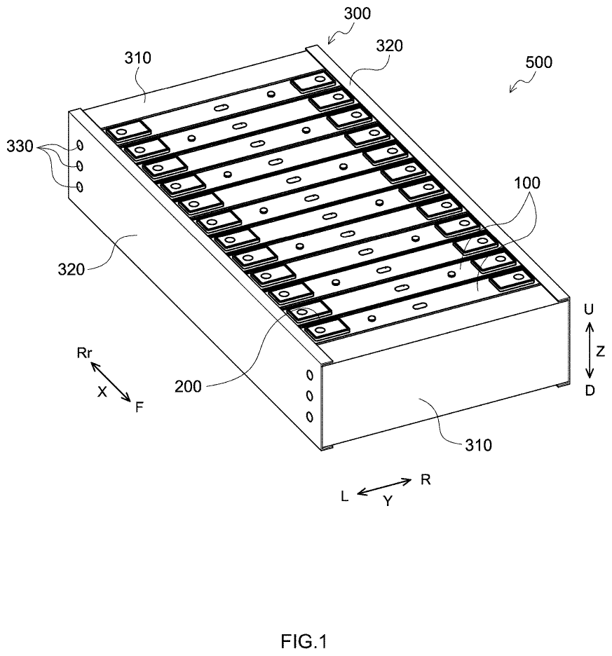

FIG. 1 is a perspective view schematically illustrating a battery pack 500 according to an embodiment. The battery pack 500 here includes a plurality of rectangular secondary batteries 100, a plurality of porous elastic members 200, and a restriction mechanism 300.

In the following description, reference signs L, R, F, Rr, U, and D in the drawings respectively denote left, right, front, rear, up, and down, and reference signs X, Y, and Z in the drawings respectively denote a short side direction of the rectangular secondary battery 100, and a long side direction and an up-down direction thereof that are orthogonal to the short side direction. The short side direction X also corresponds to an arrangement direction of the rectangular secondary batteries 100. These directions are defined however for convenience of explanation, and do not limit the manner in which the battery pack 500 is disposed.

The restriction mechanism 300 is configured to apply prescribed restriction pressure on the rectangular secondary batteries 100 and the porous elastic members 200 from the arrangement direction X. The restriction mechanism 300 here includes a pair of end plates 310, a pair of side plates 320, and a plurality of screws 330. The pair of end plates 310 is arranged in the predetermined arrangement direction X. The pair of end plates 310 is disposed on both ends of the battery pack 500 in the arrangement direction X. The rectangular secondary batteries 100 are disposed between the pair of end plates 310 along the arrangement direction X. The porous elastic members 200 are each disposed between the rectangular secondary batteries 100 that are adjacent in the arrangement direction X. The pair of end plates 310 holds the rectangular secondary batteries 100 and the porous elastic members 200 therebetween in the arrangement direction X.

The pair of side plates 320 bridges over the pair of end plates 310. The pair of side plates 320 is fixed to the end plates 310 by the screws 330 so that a restriction load is generally about 10 to 15 kN, for example. Thus, the restriction load is applied on the rectangular secondary batteries 100 and the porous elastic members 200 from the arrangement direction X and accordingly, the battery pack 500 is held integrally. The restriction mechanism is, however, not limited to this example. In another example, the restriction mechanism 300 may alternatively include a plurality of restriction bands, bind bars, or the like instead of the side plates 320.

The rectangular secondary battery 100 is a battery that is capable of being charged and discharged repeatedly. Note that in the present specification, the term “secondary battery” refers to general power storage devices that are capable of being charged and discharged repeatedly, and corresponds to a concept encompassing so-called storage batteries (chemical batteries) such as lithium ion secondary batteries and nickel-hydrogen batteries, and capacitors (physical batteries) such as lithium ion capacitors and electrical double-layer capacitors. The shape, the size, the number, the arrangement, the connection method, and the like of the rectangular secondary batteries 100 included in the battery pack 500 are not limited to the aspect disclosed herein, and can be changed as appropriate.

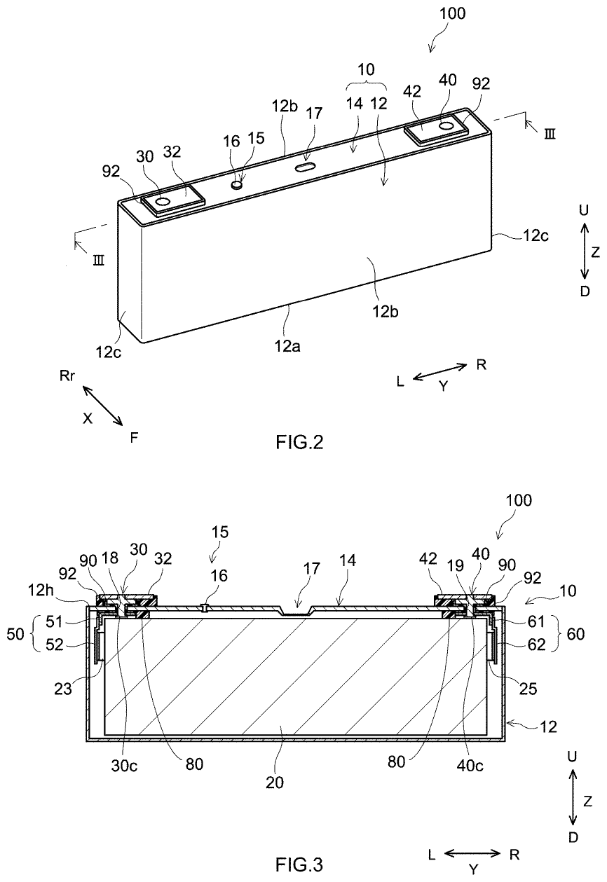

FIG. 2 is a perspective view of the rectangular secondary battery 100. As illustrated in FIG. 1 and FIG. 2, the rectangular secondary batteries 100 are arranged in the arrangement direction X through the porous elastic members 200 so that long side walls 12b, which are described below, oppose each other. FIG. 3 is a schematic longitudinal cross-sectional view taken along line in FIG. 2. As illustrated in FIG. 3, the rectangular secondary battery 100 includes a battery case 10, an electrode body group 20, a positive electrode terminal 30, a negative electrode terminal 40, a positive electrode current collecting part 50, a negative electrode current collecting part 60, and a nonaqueous electrolyte solution (not shown). The rectangular secondary battery 100 is a lithium ion secondary battery here.

The battery case 10 is a housing that accommodates the electrode body group 20 and the nonaqueous electrolyte solution. As illustrated in FIG. 1, the external shape of the battery case 10 is a flat and bottomed cuboid shape (rectangular shape). A conventionally used material can be used for the battery case 10, without particular limitations. The battery case 10 is preferably made of metal, and for example, more preferably made of aluminum, aluminum alloy, iron, iron alloy, or the like. As illustrated in FIG. 2, the battery case 10 includes an exterior body 12 having an opening 12h, and a sealing plate (lid body) 14 that seals the opening 12h. The battery case 10 preferably includes the exterior body 12 having the opening 12h and the sealing plate 14 that seals the opening 12h as described in the present embodiment.

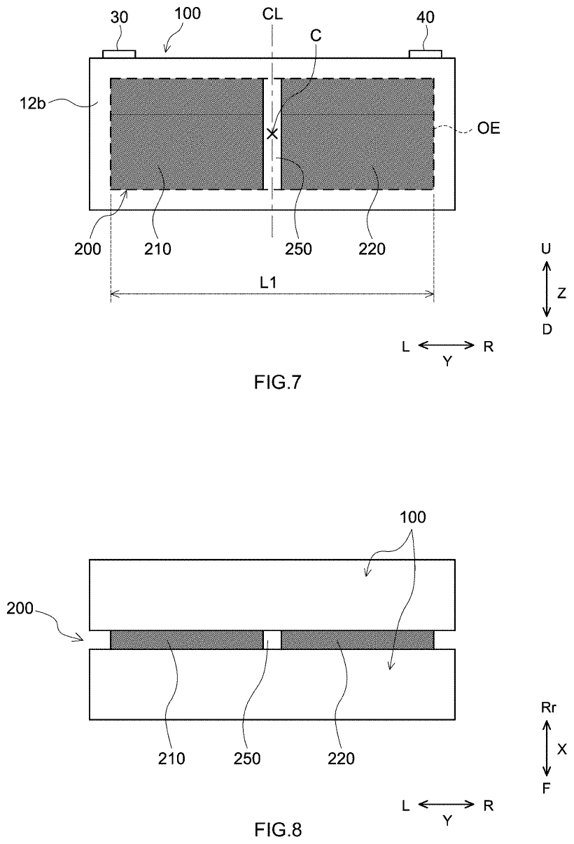

As illustrated in FIG. 2, the exterior body 12 includes a bottom wall 12a, a pair of long side walls 12b extending from the bottom wall 12a and opposing each other, and a pair of short side walls 12c extending from the bottom wall 12a and opposing each other. The bottom wall 12a is substantially rectangular in shape. The bottom wall 12a opposes the opening 12h. The long side wall 12b has a flat shape. As illustrated in FIG. 1, the long side wall 12b is a surface that opposes the porous elastic member 200 (also see FIG. 7 and FIG. 8). The long side wall 12b is, here, in direct contact with the porous elastic member 200. The long side wall 12b and the short side wall 12c are one example of a first side wall and a second side wall disclosed herein.

In a plan view, the long side wall 12b is larger in area than the short side wall 12c. Although not particularly limited, in a high-capacity type that may be used as an on-vehicle battery or the like, the area of the long side wall 12b may be generally 10000 mm² or more, preferably 15000 mm² or more, more preferably 20000 mm² or more, still more preferably 25000 mm² or more, and particularly preferably 30000 mm² or more. If the area of the long side wall 12b is large, air permeates less readily to the inside of the porous elastic member 200, which is described below, particularly to a center part in the long side direction Y. Thus, it is particularly effective to apply the art disclosed herein. From the viewpoint of obtaining the effect of the art disclosed herein at a high level, the area of the long side wall 12b is preferably generally 150000 mm² or less.

The long side wall 12b is preferably horizontally long. That is to say, the length in the long side direction Y is preferably longer than the length in the up-down direction Z. The length of the long side wall 12b in the long side direction Y is preferably 200 mm or more, and the length thereof in the up-down direction Z is preferably 100 mm or more. As the distance between the center and the edge is longer, it is more effective to apply the art disclosed herein. In the long side wall 12b, the ratio (ratio of height/width) of the length in the up-down direction Z to the length in the long side direction Y is preferably 1/1 to ⅔, more preferably ⅔ to ⅓, and still more preferably ⅓ to 1/15.

The sealing plate 14 is attached to the exterior body 12 so as to cover the opening 12h of the exterior body 12. The sealing plate 14 opposes the bottom wall 12a of the exterior body 12. The sealing plate 14 is substantially rectangular in shape in a plan view. The battery case 10 is unified in a manner that the sealing plate 14 is joined (preferably, joined by welding) to a periphery of the opening 12h of the exterior body 12. The battery case 10 is hermetically sealed (closed).

As illustrated in FIG. 3, a liquid injection hole 15, a gas discharge valve 17, and two terminal extraction holes 18 and 19 are provided in the sealing plate 14. The liquid injection hole 15 is provided for the purpose of injecting the nonaqueous electrolyte solution after the sealing plate 14 is assembled to the exterior body 12. The liquid injection hole 15 is sealed by a sealing member 16. The gas discharge valve 17 is configured to break when the pressure in the battery case 10 becomes more than or equal to a predetermined value so as to discharge the gas out of the battery case 10. The terminal extraction holes 18 and 19 penetrate the sealing plate 14 in the up-down direction Z. The terminal extraction holes 18 and 19 each have the inner diameter that enables the positive electrode terminal 30 and the negative electrode terminal 40, which have not been attached to the sealing plate 14 yet (before a caulking process), to pass therethrough.

The nonaqueous electrolyte solution may be similar to the conventional nonaqueous electrolyte solution, without particular limitations. The nonaqueous electrolyte solution contains a nonaqueous solvent and a supporting salt (electrolyte salt). The nonaqueous electrolyte solution may additionally contain an additive as necessary. Examples of the nonaqueous solvent include carbonates such as ethylene carbonate, dimethyl carbonate, and ethyl methyl carbonate. The nonaqueous solvent preferably contains carbonates, particularly cyclic carbonates and chained carbonates. Examples of the supporting salt include fluorine-containing lithium salts such as lithium hexafluorophosphate (LiPF₆).

The positive electrode terminal 30 is disposed at an end part of the sealing plate 14 on one side in the long side direction Y (left end part in FIG. 2 and FIG. 3). The negative electrode terminal 40 is disposed at an end part of the sealing plate 14 on the other side in the long side direction Y (right end part in FIG. 2 and FIG. 3). As illustrated in FIG. 3, the positive electrode terminal 30 and the negative electrode terminal 40 extend from the inside to the outside of the sealing plate 14 through the terminal extraction holes 18 and 19. The positive electrode terminal 30 and the negative electrode terminal 40 are fixed to the sealing plate 14. The positive electrode terminal 30 and the negative electrode terminal 40 are here caulked to a peripheral part of the sealing plate 14 that surrounds the terminal extraction holes 18 and 19 by the caulking process. Caulking parts 30c and 40c are formed at an end part of the positive electrode terminal 30 and the negative electrode terminal 40 on the exterior body 12 side (lower end part in FIG. 3).

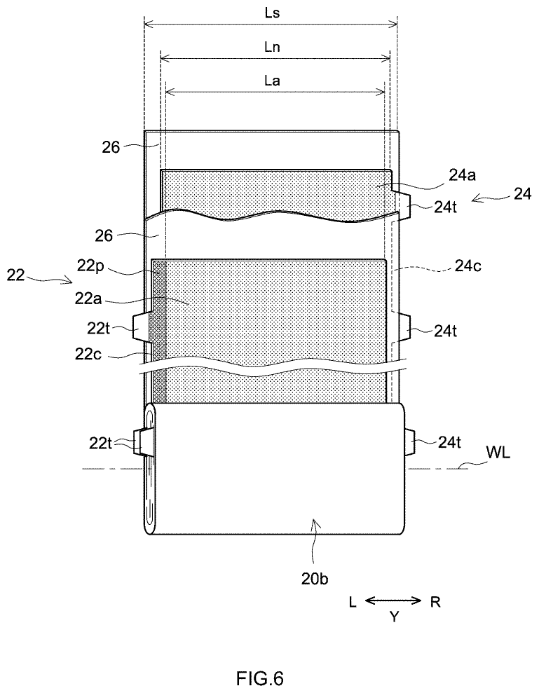

As illustrated in FIG. 3, the positive electrode terminal 30 is electrically connected to a positive electrode 22 (see FIG. 6) of the electrode body group 20 through the positive electrode current collecting part 50 inside the exterior body 12. The negative electrode terminal 40 is electrically connected to a negative electrode 24 (see FIG. 6) of the electrode body group 20 through the negative electrode current collecting part 60 inside the exterior body 12. The positive electrode terminal 30 is insulated from the sealing plate 14 by an internal insulation member 80 and a gasket 90. The negative electrode terminal 40 is insulated from the sealing plate 14 by the internal insulation member 80 and the gasket 90.

A positive electrode external conductive member 32 and a negative electrode external conductive member 42, each having a plate shape, are attached to an external surface of the sealing plate 14. The positive electrode external conductive member 32 is electrically connected to the positive electrode terminal 30. The negative electrode external conductive member 42 is electrically connected to the negative electrode terminal 40. The positive electrode external conductive member 32 and the negative electrode external conductive member 42 are members to which a busbar or the like that electrically connects the rectangular secondary batteries 100 to each other is attached. The positive electrode external conductive member 32 and the negative electrode external conductive member 42 are insulated from the sealing plate 14 by an external insulation member 92. When the battery pack 500 is used, the adjacent rectangular secondary batteries 100 are electrically connected to each other, although the illustration is omitted in FIG. 1. For example, in the adjacent rectangular secondary batteries 100, the positive electrode external conductive member 32 of one rectangular secondary battery 100 and the negative electrode external conductive member 42 of the other rectangular secondary battery 100 are electrically connected to each other by the busbar or the like. Thus, the battery pack 500 is electrically connected in series.

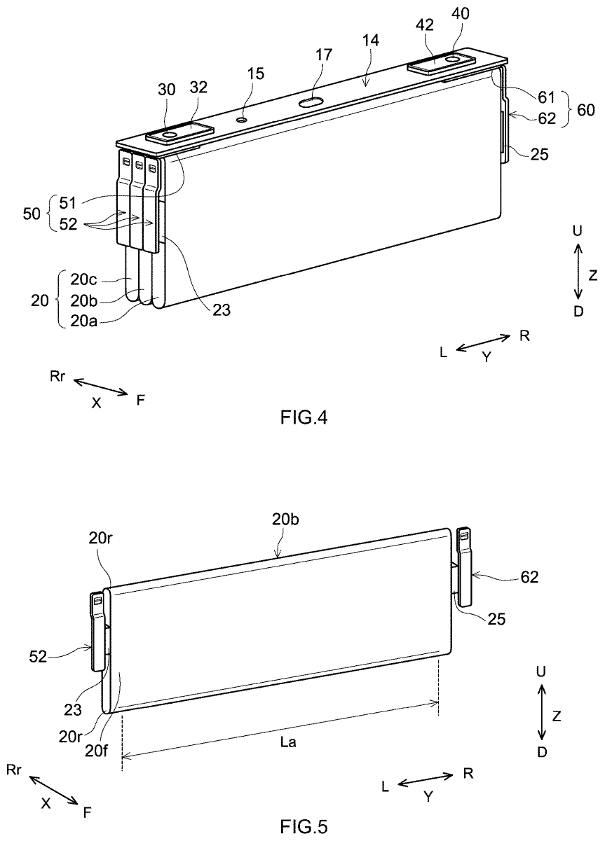

FIG. 4 is a perspective view schematically illustrating the electrode body group 20 attached to the sealing plate 14. The electrode body group 20 includes a plurality of electrode bodies. The structure of the electrode body may be similar to the conventional structure thereof, without particular limitations. The electrode body group 20 here includes three electrode bodies 20a, 20b, and 20c. The number of electrode bodies to be disposed in one exterior body 12 is, however, not limited in particular and may be two, or four or more. The electrode bodies 20a, 20b, and 20c are electrically connected to each other in parallel here. The electrode bodies 20a, 20b, and 20c are arranged in the short side direction X. The external shape of each of the electrode bodies 20a, 20b, and 20c is a flat shape. Each of the electrode bodies 20a, 20b, and 20c is a wound electrode body here. The electrode bodies 20a, 20b, and 20c are disposed inside the exterior body 12 with their winding axes WL (see FIG. 6) approximately parallel to the long side direction Y. An end surface of the electrode body 20a that is orthogonal to the winding axis WL (in other words, a stack surface where the positive electrode 22 and the negative electrode 24 are stacked) opposes the short side wall 12c.

FIG. 5 is a perspective view schematically illustrating the electrode body 20b. Although the electrode body 20b is described in detail below as an example, the electrode bodies 20a and 20c can also have the similar structure. The electrode body 20b has a pair of curved parts (R parts) 20r, and a flat part 20f coupling the pair of curved parts 20r. One curved part 20r (upper side in FIG. 5) opposes the sealing plate 14, and the other curved part 20r (lower side in FIG. 5) opposes the bottom wall 12a of the exterior body 12. The flat part 20f opposes the long side wall 12b of the exterior body 12. In the electrode bodies 20a, 20b, and 20c that are adjacent in the short side direction X, the respective flat parts 20f oppose each other.

FIG. 6 is a schematic view illustrating a structure of the electrode body 20b. The electrode body 20b includes the positive electrode 22, the negative electrode 24, and a separator 26. The electrode body 20b has a structure in which, here, the positive electrode 22 with a band shape and the negative electrode 24 with a band shape are stacked across the separator 26 with a band shape and wound using the winding axis WL as a center. The winding axis WL direction is approximately parallel to the long side direction Y. In another embodiment, the electrode body 20b may be a stack type electrode body formed in a manner that a plurality of square (typically, rectangular) positive electrodes and a plurality of square (typically, rectangular) negative electrodes are stacked in an insulated state.

The positive electrode 22 may be similar to the conventional positive electrode, without particular limitations. As illustrated in FIG. 6, the positive electrode 22 has a positive electrode core body 22c, and a positive electrode active material layer 22a and a positive electrode protection layer 22p that are fixed on at least one surface of the positive electrode core body 22c. The positive electrode protection layer 22p is not essential, and can be omitted in another embodiment. The positive electrode core body 22c has a band shape. The positive electrode core body 22c is preferably made of metal, and more preferably made of a metal foil. The positive electrode core body 22c is an aluminum foil here.

At one end part of the positive electrode core body 22c in the long side direction Y (left end part in FIG. 6), a plurality of positive electrode tabs 22t are provided. The positive electrode tabs 22t protrude toward one side in the long side direction Y (left side in FIG. 6). The positive electrode tabs 22t protrude in the long side direction Y more than the separator 26. The positive electrode tab 22t constitutes a part of the positive electrode core body 22c here, and is made of a metal foil (aluminum foil). As illustrated in FIG. 3 to FIG. 6, the positive electrode tabs 22t are stacked at one end part in the long side direction Y (left end part in FIG. 3 to FIG. 6), and form a positive electrode tab group 23. The positive electrode tab group 23 is electrically connected to the positive electrode terminal 30 through the positive electrode current collecting part 50.

The positive electrode active material layer 22a is formed to have a band shape along a longitudinal direction of the positive electrode core body 22c as illustrated in FIG. 6. The positive electrode active material layer 22a includes a positive electrode active material that is capable of reversibly storing and releasing charge carriers. Examples of the positive electrode active material include a lithium-transition metal complex oxide. Further, the positive electrode active material layer 22a may contain an optional component other than the positive electrode active material, for example, various additive components such as a binder or a conductive material.

The positive electrode protection layer 22p is provided at a border part between the positive electrode core body 22c and the positive electrode active material layer 22a in the long side direction Y as illustrated in FIG. 6. The positive electrode protection layer 22p is formed to have a band shape along the positive electrode active material layer 22a. The positive electrode protection layer 22p contains inorganic filler (for example, alumina). The positive electrode protection layer 22p may contain an optional component other than the inorganic filler, such as a conductive material, a binder, or various additive components.

The negative electrode 24 may be similar to the conventional negative electrode, without particular limitations. As illustrated in FIG. 6, the negative electrode 24 has a negative electrode core body 24c, and a negative electrode active material layer 24a that is fixed on at least one surface of the negative electrode core body 24c. The negative electrode core body 24c has a band shape. The negative electrode core body 24c is preferably made of metal, and more preferably made of a metal foil. The negative electrode core body 24c is a copper foil here.

At one end part of the negative electrode core body 24c in the long side direction Y (right end part in FIG. 6), a plurality of negative electrode tabs 24t are provided. The negative electrode tabs 24t protrude toward one side in the long side direction Y (right side in FIG. 6). The negative electrode tabs 24t protrude in the long side direction Y more than the separator 26. The negative electrode tab 24t constitutes a part of the negative electrode core body 24c here, and is made of a metal foil (copper foil). As illustrated in FIG. 3 to FIG. 6, the negative electrode tabs 24t are stacked at one end part in the long side direction Y (right end part in FIG. 3 to FIG. 6), and form a negative electrode tab group 25. The negative electrode tab group 25 is provided at a position that is symmetrical to the positive electrode tab group 23 in the long side direction Y. The negative electrode tab group 25 is electrically connected to the negative electrode terminal 40 through the negative electrode current collecting part 60.

The negative electrode active material layer 24a is formed to have a band shape along a longitudinal direction of the negative electrode core body 24c as illustrated in FIG. 6. A length Ln of the negative electrode active material layer 24a in the long side direction Y is more than or equal to the length La of the positive electrode active material layer 22a in the long side direction Y. The negative electrode active material layer 24a includes a negative electrode active material that is capable of reversibly storing and releasing the charge carriers. Examples of the negative electrode active material include a carbon material such as graphite. The negative electrode active material layer 24a may contain an optional component other than the negative electrode active material, for example, various additive components such as a binder, a thickener, or a dispersant.

The separator 26 is disposed between the positive electrode 22 and the negative electrode 24. The separator 26 is a member that insulates between the positive electrode 22 the negative electrode 24. A length Ls of the separator 26 in the long side direction Y is longer than or equal to the length Ln of the negative electrode active material layer 24a in the long side direction Y. The separator 26 is suitably a porous sheet made of resin including polyolefin resin such as polyethylene (PE) or polypropylene (PP).

As illustrated in FIG. 3, the positive electrode current collecting part 50 forms a conductive path for electrically connecting the positive electrode terminal 30 and the positive electrode tab group 23 formed by the positive electrode tabs 22t. The positive electrode current collecting part 50 includes a positive electrode first current collecting part 51 and a positive electrode second current collecting part 52. The positive electrode first current collecting part 51 is attached to an inner surface of the sealing plate 14. The positive electrode second current collecting part 52 extends along the short side wall 12c of the exterior body 12. As illustrated in FIG. 3 to FIG. 5, the positive electrode second current collecting part 52 is attached to the electrode body 20b.

As illustrated in FIG. 3, the negative electrode current collecting part 60 forms a conductive path for electrically connecting the negative electrode terminal 40 and the negative electrode tab group 25 formed by the negative electrode tabs 24t. The negative electrode current collecting part 60 includes a negative electrode first current collecting part 61 and a negative electrode second current collecting part 62. The negative electrode first current collecting part 61 and the negative electrode second current collecting part 62 may have structures similar to those of the positive electrode first current collecting part 51 and the positive electrode second current collecting part 52 of the positive electrode current collecting part 50, respectively.

As described above, the porous elastic members 200 are each disposed between the rectangular secondary batteries 100 in the arrangement direction X here. That is to say, in the arrangement direction X, the rectangular secondary batteries 100 and the porous elastic members 200 are arranged alternately. Note that it is only necessary that the porous elastic member 200 is disposed between at least two rectangular secondary batteries 100 that are adjacent in the arrangement direction X, and it is not always necessary that the porous elastic member 200 is disposed between all the rectangular secondary batteries 100. The porous elastic members 200 may be disposed between preferably 50% or more and more preferably 80% or more of the rectangular secondary batteries 100. The porous elastic member 200 may be separable from the rectangular secondary battery 100, or inseparable from the rectangular secondary battery 100 by being fixed thereto. For example, the porous elastic member 200 may be held between the two rectangular secondary batteries 100 that oppose each other, or adhered to the rectangular secondary battery 100 by an adhesive, a tape, or the like. The porous elastic member 200 is in direct contact with the long side wall 12b of the rectangular secondary battery 100 here. Between the rectangular secondary battery 100 and the porous elastic member 200, however, a different member can exist, which is described in a modification below.

The porous elastic member 200 is configured to be deformable elastically at least in the arrangement direction X. Although not particularly limited, the elastic force of the porous elastic member 200 may be generally 1 kN/mm to 10^{×3} kN/mm. The porous elastic member 200 has a porous structure including a plurality of communication holes that communicate with the outside. The porous elastic member 200 may have a three-dimensional mesh shape including communication holes that communicate with each other three-dimensionally. The porosity of the porous elastic member 200 (the volume of the pores/the volume of the porous elastic member 200) is preferably 10 to 90 vol %, more preferably 20 to 80 vol %, and still more preferably 25 to 75 vol %. Thus, the effect of the art disclosed herein can be obtained at the high level. The porous elastic member 200 is preferably formed of a resin material. Examples of the resin material include natural rubber, synthetic rubber, silicone resin, urethane resin, and the like.

If the rectangular secondary battery 100 expands in the charge or the like, a load on the porous elastic member 200 becomes large. Thus, air is vented (discharged) from the porous elastic member 200, and the porous elastic member 200 is compressed. Therefore, the excessive restriction load that is more than or equal to a predetermined load can be prevented from being applied on the rectangular secondary battery 100. On the other hand, if the rectangular secondary battery 100 shrinks in the discharge or the like, the load on the porous elastic member 200 becomes small. Thus, the porous elastic member 200 inhales air (takes in air) from the outside to expand, and accordingly, the shape thereof becomes the original one again. Therefore, the rectangular secondary battery 100 can be stably pressed by the restriction load that is more than or equal to the predetermined load.

The shape, the size, and the arrangement of the porous elastic member 200 can be determined as appropriate depending on the shape, the size, the capacity (degree of expansion and shrinkage), or the like of the rectangular secondary battery 100, for example. The thickness of the porous elastic member 200 is, in a state before the porous elastic member 200 is assembled to the battery pack 500 and compressed, preferably 1 to 10 mm, more preferably 1 to 8 mm, and still more preferably 3 to 5 mm. The thickness of the porous elastic member 200 (length in the arrangement direction X) is, in a state after the porous elastic member 200 is assembled to the battery pack 500 and compressed, preferably 2 to 9 mm, more preferably 3 to 8 mm, and still more preferably 4 to 7 mm.

FIG. 7 is a plan view schematically illustrating a positional relation between the rectangular secondary battery 100 and the porous elastic member 200. Note that in FIG. 7, the rectangular secondary battery 100 is simplified, that is, reference signs of components other than the positive electrode terminal 30, the negative electrode terminal 40, and the long side wall 12b are omitted. As illustrated in FIG. 7, the porous elastic member 200 includes, here, a first part 210 and a second part 220. The first part 210 and the second part 220 are disposed apart from each other in the long side direction Y that is orthogonal to the arrangement direction X. The first part 210 and the second part 220 have the same shape here, specifically, a substantially rectangular shape. However, other shapes (for example, substantially circular shape or elliptical shape) can be employed. The porous elastic member 200 is line symmetrical about a center line CL of the long side wall 12b of the rectangular secondary battery 100 in one direction (here, long side direction Y). A total length L1 of the porous elastic member 200 in the long side direction Y may be approximately the same (generally, about ±1 cm) as the length (average length) La (see FIG. 6) of the positive electrode active material layer 22a in the long side direction Y. The total length L1 may be shorter than the length Ls of the separator 26 in the long side direction Y.

In the long side direction Y, a space 250 exists between the first part 210 and the second part 220. In FIG. 7, a dashed line illustrates an outer edge OE when the porous elastic member 200 is assembled to the battery pack 500, that is, the outermost shape that can be seen from the outside in the state of the battery pack 500. The space 250 is one example of a gas flow channel extending from the outer edge OE of the porous elastic member 200 to the inside. In the present embodiment, the space 250 extends like a line (for example, like a straight line) along the up-down direction Z in a plan view. The space 250 is formed so as to penetrate the porous elastic member 200 from an upper side U to a lower side D. In other words, the space 250 opens at both ends in the up-down direction Z. The space 250 is formed so as to include a center C of the long side wall 12b of the rectangular secondary battery 100. The space 250 is formed so as to include a center part (especially, center line CL) of the rectangular secondary battery 100 in the long side direction Y. The thickness of the center part of the long side wall 12b largely changes in the charge and the discharge. Air permeates less readily to a part of the porous elastic member 200 that opposes the center part of the long side wall 12b in particular. Thus, when the space 250 includes the center C of the long side wall 12b and/or the center part in the long side direction Y, the effect of the art disclosed herein can be obtained at the high level.

The area of the porous elastic member 200 in the plan view is preferably 10,000 mm² or more, more preferably 15,000 mm² or more, and still more preferably 25,000 mm² or more. The ratio of the area of the porous elastic member 200 to the area of the long side wall 12b is preferably generally 50% or more, more preferably 60% or more or 70% or more, still more preferably 75% or more, and particularly preferably 80% or more. In these cases, since air permeates less readily to the inside of the porous elastic member 200, it is particularly effective to apply the art disclosed herein. Moreover, from the view point of obtaining the effect of the art disclosed herein at the high level, the ratio of the area is preferably generally 95% or less, preferably 90% or less, and more preferably 85% or less.

Note that in the present specification, “the area of the porous elastic member 200 in the plan view” is an area that is in contact with an opposing member (here, the long side wall 12b). For example, if the porous elastic member 200 includes a plurality of parts, this area corresponds to the total area of these parts, and for example in FIG. 7, corresponds to the total of the area of the first part 210 and the area of the second part 220. Moreover, if the porous elastic member 200 includes a part that is not in contact with the opposing member, that is, a slit, a concave part, or the like as will be described in modifications, the area of the slit, the concave part, or the like is excluded.

FIG. 8 is a partial enlarged view of a main part of the battery pack 500 viewed from above, and a top view schematically illustrating the rectangular secondary batteries 100 and the porous elastic member 200. As illustrated in FIG. 8, the porous elastic member 200 includes the space 250 between the first part 210 and the second part 220 in the state where the porous elastic member 200 is assembled to the battery pack 500. The space 250 is the gas flow channel that communicates with outside air. Thus, even in the state where the porous elastic member 200 is assembled to the battery pack 500, air can be taken in easily through the space 250. Therefore, when the rectangular secondary battery 100 shrinks, the shape of the porous elastic member 200 can be returned to the original one stably, and an unintended decrease in the restriction load of the battery pack 500 can be suppressed.

The battery pack 500 is usable in various applications, and for example, can be suitably used as a motive power source for a motor (power source for driving) that is mounted in a vehicle such as a passenger car or a truck. The vehicle is not limited to a particular type, and may be, for example, a plug-in hybrid electric vehicle (PHEV), a hybrid electric vehicle (HEV), or a battery electric vehicle (BEV).

Although the preferable embodiments of the present invention have been described above, they are merely examples. The present invention can be implemented in various other modes. The present invention can be implemented based on the contents disclosed in this specification and the technical common sense in the relevant field. The techniques described in the scope of claims include those in which the embodiments exemplified above are variously modified and changed. For example, a part of the aforementioned embodiment can be replaced by another modified example, and the other modified example can be added to the aforementioned embodiment. Additionally, the technical feature may be deleted as appropriate unless such a feature is described as an essential element.

For example, in the embodiment described above, as illustrated in FIG. 7, the porous elastic member 200 includes two parts, that is, the first part 210 and the second part 220 that are disposed apart from each other in the long side direction Y, and the space 250 between the first part 210 and the second part 220 forms the gas flow channel. However, the porous elastic member 200 may include three or more parts. Moreover, the first part 210 and the second part 220 may be disposed apart from each other in the up-down direction Z instead of the long side direction Y.

<First Modification>

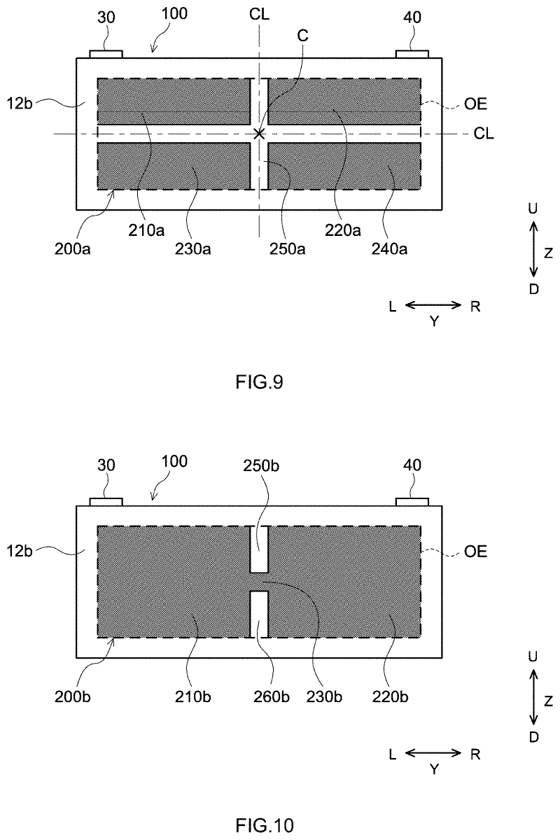

FIG. 9 is a diagram corresponding to FIG. 7 in a first modification. In the present modification, a porous elastic member 200a may be similar to the porous elastic member 200 described above except that the porous elastic member 200a includes four parts, that is, a first part 210a and a second part 220a that are disposed apart from each other in the long side direction Y on an upper side in the up-down direction Z, and a third part 230a and a fourth part 240a that are disposed apart from each other in the long side direction Y on a lower side in the up-down direction Z. The porous elastic member 200a is line symmetrical about center lines CL indicated by dashed lines in the long side direction Y and the up-down direction Z. The porous elastic member 200a includes a cross-shape space 250a between the four parts. The space 250a is formed so as to include the center C of the long side wall 12b of the rectangular secondary battery 100. The space 250a is formed so as to include each of center parts (especially, center lines CL) of the rectangular secondary battery 100 in the long side direction Y and the up-down direction Z. The space 250a forms the gas flow channel extending from the outer edge OE of the porous elastic member 200a to the inside.

<Second Modification>

FIG. 10 is a diagram corresponding to FIG. 7 in a second modification. In the present modification, a porous elastic member 200b may be similar to the porous elastic member 200 described above except that the porous elastic member 200b includes, in addition to a first part 210b and a second part 220b, a coupling part 230b that couples the first part 210b and the second part 220b at the center of the long side direction Y, and the first part 210b, the second part 220b, and the coupling part 230b are integrally formed. The porous elastic member 200b is line symmetrical in the long side direction Y. The porous elastic member 200b includes two slits 250b and 260b between the first part 210b and the second part 220b in the long side direction Y. One slit 250b extends from an upper side of the outer edge OE to the inside. In other words, the slit 250b opens upward. The other slit 260b extends from a lower side of the outer edge OE to the inside. In other words, the slit 260b opens downward. Each of the slits 250b and 260b is one example of the gas flow channel extending from the outer edge OE of the porous elastic member 200b to the inside.

<Third Modification>

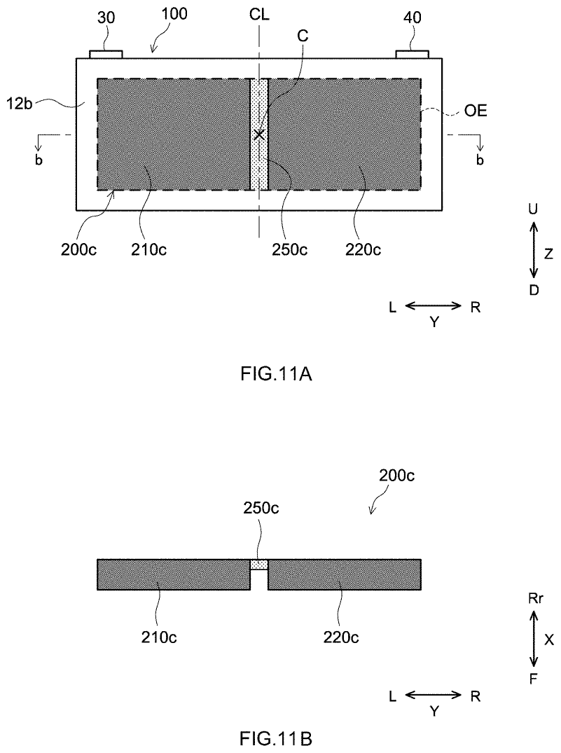

FIG. 11A is a diagram corresponding to FIG. 7 in a third modification. In the present modification, a porous elastic member 200c may be similar to the porous elastic member 200 described above except that the porous elastic member 200c includes a first part 210c and a second part 220c that are disposed on left and right in the long side direction Y and a concave part (thin part) 250c that couples the first part 210c and the second part 220c, and the first part 210c, the second part 220c, and the concave part 250c are integrally formed. Similarly to the space 250, the concave part 250c extends like a line (for example, like a straight line) along the up-down direction Z in the plan view, and is formed so as to include the center C of the long side wall 12b of the rectangular secondary battery 100. The concave part 250c is formed so as to include the center part (especially, center line CL) of the rectangular secondary battery 100 in the long side direction Y. However, the porous elastic member 200c may include two or more concave parts. In that case, the concave parts may be arranged in a predetermined direction (for example, long side direction Y) or have a stripe shape. Moreover, the concave parts may be disposed so as to intersect with each other in predetermined two or more directions (for example, the long side direction Y and the up-down direction Z).

FIG. 11B is a cross-sectional view taken along line (b)-(b) in FIG. 11A. As illustrated in FIG. 11B, the first part 210c and the second part 220c have approximately the same thickness. The concave part 250c is thinner than the first part 210c and the second part 220c. The concave part 250c is one example of the gas flow channel extending from the outer edge OE of the porous elastic member 200c to the inside.

For example, in the embodiment described above, the porous elastic member 200 is disposed between the rectangular secondary batteries 100 that are adjacent in the arrangement direction X, and both a front surface and a back surface (both surfaces in the arrangement direction X) of the porous elastic member 200 are in contact with the long side walls 12b of the rectangular secondary batteries 100. However, the different member may exist between the rectangular secondary battery 100 and the porous elastic member 200. Examples of the different member that may exist between the rectangular secondary battery 100 and the porous elastic member 200 include a non-porous insulation film; a heat-resistant member including high-melting-point resin; a heat-resistant member including a resin material and ceramic particles; a heat insulation member including a nanoporous body mainly containing silica aerogel or silica, or the like; and the like. The shape, the size, and the arrangement of the different member can be determined as appropriate depending on, for example, the shape, the size, the position of the gas flow channel, or the like of the porous elastic member 200. For example, the different member may have a sheet shape or the same shape as the porous elastic member 200.

<Fourth Modification>

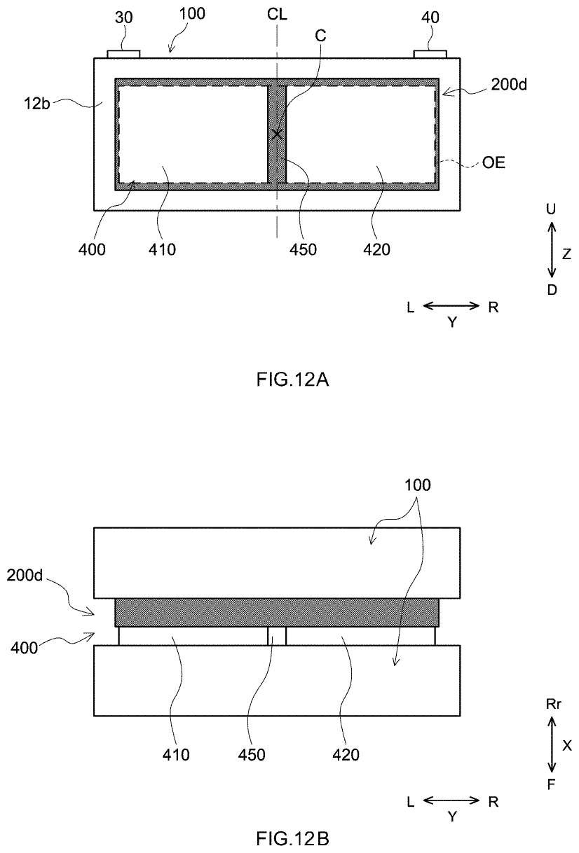

FIG. 12A is a plan view schematically illustrating a positional relation among the rectangular secondary battery 100, a porous elastic member 200d, and a different member 400. FIG. 12B is a diagram corresponding to FIG. 8 in a fourth modification. As illustrated in FIG. 12B, in the present modification, the different member 400 is in contact with the porous elastic member 200d and the gas flow channel is secured on a surface of the different member 400 that is in contact with the porous elastic member. That is to say, as illustrated in FIG. 12A, in the present modification, the porous elastic member 200d has a sheet shape with homogeneous thickness. The porous elastic member 200d may be similar to the porous elastic member 200 described above except that the porous elastic member 200d has a rectangular shape that is a little smaller than the long side wall 12b of the rectangular secondary battery 100.

The different member 400 includes a first part 410 and a second part 420 that are disposed apart from each other on left and right in the long side direction Y. The first part 410 and the second part 420 are disposed apart from each other in the long side direction Y that is orthogonal to the arrangement direction X. The first part 410 and the second part 420 have a rectangular shape that is smaller than the porous elastic member 200d, and are shorter in the length in the up-down direction Z than the porous elastic member 200d. In the long side direction Y, there is a space 450 between the first part 410 and the second part 420. A dashed line illustrates the outer edge OE when the different member 400 is assembled to the battery pack 500, that is, a part that is exposed to the outside. The space 450 is one example of the gas flow channel extending from the outer edge OE of the different member 400 to the inside.

As illustrated in FIG. 12B, in the present modification, the porous elastic member 200d is disposed between the rectangular secondary batteries 100 that are adjacent in the arrangement direction X, and the different member 400 is disposed between the rectangular secondary battery 100 and the porous elastic member 200d. Thus, one surface of the porous elastic member 200d in the arrangement direction X is in contact with the rectangular secondary battery 100, and the other surface thereof is in contact with the different member 400. The different member 400 includes the space 450 between the first part 410 and the second part 420 in a state where the different member 400 is assembled to the battery pack 500. The space 450 is the gas flow channel that communicates with outside air. Thus, even in the state where the porous elastic member 200d is assembled to the battery pack 500, the porous elastic member 200d easily takes in air through the space 450. Therefore, similarly to the case where the aforementioned porous elastic member 200 itself has the gas flow channel, when the rectangular secondary battery 100 shrinks, the shape of the porous elastic member 200 can be returned to the original one stably, and the unintended decrease in the restriction load of the battery pack 500 can be suppressed.

In the fourth modification described above, the space 450 of the different member 400 forms the gas flow channel that communicates with outside air. However, instead of the space 450, the different member 400 may have a concave part on at least a surface thereof that is contact with the porous elastic member 200d similarly to the third modification described above. In that case, the concave part may be provided to only the surface that is in contact with the porous elastic member 200d, or to both surfaces. Moreover, in the fourth modification described above, one porous elastic member 200d is disposed between the adjacent rectangular secondary batteries 100. However, two or more porous elastic members 200d may be disposed between the adjacent rectangular secondary batteries 100. For example, between the adjacent rectangular secondary batteries 100, the different member 400 that is held by a pair of porous elastic members 200d may be disposed, and both a front surface and a back surface (both surfaces in the arrangement direction X) of the different member 400 may be in contact with the porous elastic members 200d.

As described above, the following items are given as specific aspects of the art disclosed herein.

Item 1: The battery pack including: the plurality of rectangular secondary batteries that are disposed along the predetermined arrangement direction; the porous elastic member that is disposed between the rectangular secondary batteries that are adjacent in the arrangement direction; and the restriction mechanism that applies the restriction load on the rectangular secondary batteries and the porous elastic member from the arrangement direction, in which the porous elastic member includes the plurality of communication holes that communicate with the outside and is configured to be deformable elastically in the arrangement direction by taking in or discharging the gas, and at least one of the following structures (1) and (2) is satisfied: (1) the porous elastic member includes the gas flow channel extending from the outer edge to the inside in the state where the porous elastic member is assembled to the battery pack; and (2) the different member is additionally provided between the rectangular secondary battery and the porous elastic member, and the different member includes the gas flow channel extending from the outer edge to the inside on at least the surface that is in contact with the porous elastic member in the state where the different member is assembled to the battery pack.
Item 2: The battery pack according to Item 1, in which the porous elastic member and/or the different member includes the first part and the second part that are disposed apart from each other in at least one direction that is orthogonal to the arrangement direction, and the space between the first part and the second part forms the gas flow channel.
Item 3: The battery pack according to Item 1 or 2, in which the porous elastic member includes the slit extending from the outer edge to the inside in the state where the porous elastic member is assembled to the battery pack, and the slit forms the gas flow channel.
Item 4: The battery pack according to any one of Items 1 to 3, in which the porous elastic member and/or the different member includes the concave part extending from the outer edge to the inside in the state where the porous elastic member and/or the different member is assembled to the battery pack, and the concave part forms the gas flow channel.
Item 5: The battery pack according to any one of Items 1 to 4, in which the rectangular secondary battery includes the battery case and the electrode body that is accommodated in the battery case, in the battery case, the exterior body including the bottom wall, the pair of first side walls extending from the bottom wall and opposing each other, the pair of second side walls extending from the bottom wall and opposing each other, and the opening that opposes the bottom wall, and the sealing plate that seals the opening of the exterior body are joined, the first side wall opposes the porous elastic member, and the area of the first side wall is 20000 mm² or more in the plan view.
Item 6: The battery pack according to Item 5, in which the ratio of the area of the porous elastic member to the area of the first side wall is 50% or more in the plan view.
Item 7: The battery pack according to any one of Items 1 to 6, in which the porosity of the porous elastic member is 10 to 90 vol %.
Item 8: The battery pack according to any one of Items 1 to 7, in which the porous elastic member is made of resin.

### REFERENCE SIGNS LIST

OE Outer edge
10 Battery case
12 Exterior body
14 Sealing plate
20 Electrode body group
20a, 20b, 20c Electrode body
100 Rectangular secondary battery
200, 200a, 200b, 200c, 200d Porous elastic member
250, 250a Space (gas flow channel)
250b, 260b Slit (gas flow channel)
250c Concave part (gas flow channel)
300 Restriction mechanism
400 Different member
450 Space (gas flow channel)
500 Battery pack

What is claimed is:

1. A battery pack comprising:
a plurality of rectangular secondary batteries that are disposed along a predetermined arrangement direction;
a porous elastic member that is disposed between the rectangular secondary batteries that are adjacent in the arrangement direction; and
a restriction mechanism that applies a restriction load on the rectangular secondary batteries and the porous elastic member from the arrangement direction, wherein
the porous elastic member includes a plurality of communication holes that communicate with outside and is configured to be deformable elastically in the arrangement direction by taking in or discharging gas, and
at least one of the following structures (1) and (2) is satisfied:
(1) the porous elastic member includes a gas flow channel extending from an outer edge to inside in a state where the porous elastic member is assembled to the battery pack; and
(2) a different member is additionally provided between the rectangular secondary battery and the porous elastic member, and the different member includes the gas flow channel extending from the outer edge to the inside on at least a surface that is in contact with the porous elastic member in a state where the different member is assembled to the battery pack.

2. The battery pack according to claim 1, wherein
the porous elastic member and/or the different member includes a first part and a second part that are disposed apart from each other in at least one direction that is orthogonal to the arrangement direction, and
a space between the first part and the second part forms the gas flow channel.

3. The battery pack according to claim 1, wherein
the porous elastic member includes a slit extending from the outer edge to the inside in the state where the porous elastic member is assembled to the battery pack, and
the slit forms the gas flow channel.

4. The battery pack according to claim 1, wherein
the porous elastic member and/or the different member includes a concave part extending from the outer edge to the inside in the state where the porous elastic member and/or the different member is assembled to the battery pack, and
the concave part forms the gas flow channel.

5. The battery pack according to claim 1, wherein
the rectangular secondary battery includes a battery case and an electrode body that is accommodated in the battery case,
in the battery case, an exterior body including a bottom wall, a pair of first side walls extending from the bottom wall and opposing each other, a pair of second side walls extending from the bottom wall and opposing each other, and an opening that opposes the bottom wall, and a sealing plate that seals the opening of the exterior body are joined,
the first side wall opposes the porous elastic member, and
an area of the first side wall is 20000 mm² or more in a plan view.

6. The battery pack according to claim 5, wherein a ratio of an area of the porous elastic member to the area of the first side wall is 50% or more in the plan view.

7. The battery pack according to claim 1, wherein a porosity of the porous elastic member is 10 to 90 vol %.

8. The battery pack according to claim 1, wherein the porous elastic member is made of resin.
